(19) United States
(12) Patent Application Publication
(10) Pub. No.: US 2010/0120012 A1
(43) Pub. Date: May 13, 2010

(54) SYSTEM FOR PROVIDING ONLINE LEARNING CONTENTS

(76) Inventor: Duck-Yong PARK, Uijeongbu-si (KR)

Correspondence Address: CANTOR COLBURN, LLP, 20 Church Street, 22nd Floor, Hartford, CT, 06103, US

(21) Appl. No.: 12/618,087

(22) Filed: Nov. 13, 2009

(30) Foreign Application Priority Data
Nov. 13, 2008 (KR) 10-2008-112539

(51) Int. Cl. G09B 7/00

(52) U.S. Cl. 434/362

(57) ABSTRACT

Disclosed herein is a system for providing online learning contents, which can maximize efficiency of education based on analysis of a plurality of learning contents and matching of a result of the analysis to a student to meet characteristics and environments of the student. The system according to the present invention comprises at least two or more contents providers, an education management server, an authentication server, and a web server. Accordingly, since a student can be provided with an education corresponding to the inclination of the student, effect of online education can be enhanced.

### BACKGROUND OF THE INVENTION

### 1. Field of the Invention

The present invention relates to an online learning system, and more specifically, to a system for providing online learning contents, in which education can be provided depending on the gender, grade, and tastes of a learner on the basis of a plurality of learning contents collected and analyzed.

2. Background of the Related Art

Conventionally, it is general that learning is performed on an offline space, such as a school, private educational institute, and the like. However, as possibility of the Internet as a learning means is highlighted recently, utilization and contribution of the Internet on the web are gradually increased. In addition, experts forecast that the proportion of online occupied in learning service will further grow in the future.

In such conventional learning service provided online, it is general that a menu is managed in a method of adding a menu item to an existing menu whenever a learning material is added. As a result, although learning materials are of the same subject, the learning materials are distributed by the type of each learning material, and thus it is inconvenient in that a learning material should be searched for through a different menu path each time.

Accordingly, methods of providing online education implementing one-to-one bidirectional communication as an online learning method are disclosed. Describing specifically, a conventional method of providing online education comprises the steps of authenticating a user connected through the Internet, receiving a request for searching for a learning material from the user connected through the Internet, searching for a learning material corresponding to the search request, collectively providing display items, which are related to various types of learning materials of at least two or more of a curriculum material, question material, electronic board lecture material, moving image lecture material, and electronic book corresponding to final classification items, as an integrated user interface (UI) menu on a web page based on a search result, and providing a learning material corresponding to a selected display item on a separate active window when the user selects at least one of the display items, thereby enhancing efficiency of online learning.

Here, the UI menu is displayed on a web page separately from the active window. When the user selects another item among the display items displayed on the UI menu, a learning material corresponding to the selected display item can be provided on another active window. A user can be classified as a student member, a parent member, or a teacher member, and the teacher member may search for and select a learning material and transmit the learning material as an assignment to student members in person or group.

Accordingly, it is possible to inquire at least one of those including time of reading the assignment, time taken to solve a problem, time of listening to the lecture, and number of times watching the lecture of a student member, who is the target of transmitting the assignment, or the student member may receive and perform the assignment and transmit a result of the assignment to the teacher member, together with a message. Then, the teacher member teaches by correcting the performed assignment and transmits the corrected assignment to the student member, thereby providing one-to-one education.

In addition, questions wrongly answered by the student member are stored in a wrong answer box, and furthermore, results of solving problems by the student members are stored, and statistics of record information accumulated in relation to the results of solving problems is provided so that weak units and learning accomplishment can be grasped through the statistics of record information. As a result, display items of various types of learning materials corresponding to a final classification item are collectively provided through the integrated UI on a web page, and thus convenience of users can be pursued.

However, although the conventional online education provides user convenience as a kind of an education type or learning method as described above, this is merely mapping offline education to an online space, and thus practical improvement in quality of education cannot be achieved. Accordingly, alternative measures for creating only the effect of online education, which cannot be provided by offline education, are needed.

### SUMMARY OF THE INVENTION

The present invention has been made in view of the above problems occurring in the prior art, and it is an object of the present invention to provide a system for providing online learning contents, which can maximize efficiency of education based on analysis of a plurality of learning contents and matching of a result of the analysis to a student to meet characteristics and environments of the student.

Another object of the present invention is to provide a system for providing online learning contents, in which a student is allowed to select contents by each learning level suggested by contents providers who provide educational information, and thus online learning appropriate to inclination, aptitude, learning level, and the like of the student can be provided.

To accomplish the above object, according to one aspect of the present invention, there is provided a system for providing online learning contents, the system comprising: at least two or more contents providers for configuring and providing online learning contents corresponding to a certain movement-to-higher-grade or a certain grade by the unit; an education management server for classifying the online learning contents provided by the contents provider by the movement-to-higher-grade, unit, and web design of each unit, analyzing the online learning contents by the degree of difficulty of learning and the gender and taste of a student based on the classification, and providing corresponding contents depending on the educational aptitude and selection of the student; an authentication server for admitting as a member and authenticating the contents providers, managing and authenticating student members in relation to online contents, and approving online distribution of contents registered in the education management server, on the basis of membership authentication of the contents provider and the student; and a web server for transmitting certain online contents approved by the authentication server to a member terminal of a registered member connected in a wired or wireless manner.

In the system for providing online learning contents according to the present invention, online education methods forcibly provided by contents providers are avoided, and a student is allowed to select a plurality of contents. Therefore, it is effective in that since the student can be provided with education corresponding to inclination of the student, effect of the online education is enhanced, and improvement in quality of the contents providers can be expected.

### BRIEF DESCRIPTION OF THE DRAWINGS

FIG. 1 is a view showing the configuration of a system for providing online learning contents according to the present invention.

FIG. 2 is a configuration diagram illustrating major functions of an education management server of FIG. 1.

FIG. 3 is a configuration diagram illustrating operation of an aptitude analysis module according to FIG. 2.

FIG. 4 is a configuration diagram illustrating operation of a contents analysis module of FIG. 2.

### DETAILED DESCRIPTION OF THE PREFERRED EMBODIMENT

The preferred embodiments of the invention will be hereafter described in detail, with reference to the accompanying drawings.

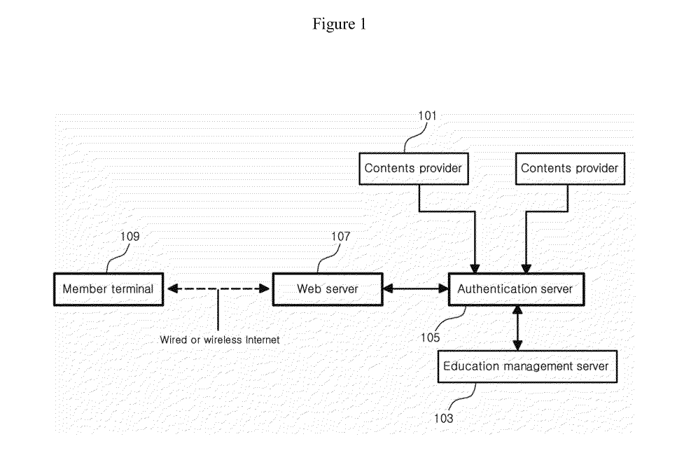

FIG. 1 is a view showing the configuration of a system for providing online learning contents according to the present invention. As shown in FIG. 1, the system comprises at least two or more contents providers 101 for configuring and providing online learning contents corresponding to a certain movement-to-higher-grade or a certain grade by the unit, an education management server 103 for classifying the online learning contents provided by the contents provider 101 by the movement-to-higher-grade, unit, and web design of each unit, analyzing the online learning contents by the degree of difficulty of learning and the gender and taste of a student based on the classification, and providing corresponding contents depending on the educational aptitude and selection of the student, an authentication server 105 for admitting as a member and authenticating the contents providers 101, managing and authenticating student members in relation to online contents, and approving online distribution of contents registered in the education management server 103, on the basis of membership authentication of the contents provider 101 and the student, and a web server 107 for transmitting certain online contents approved by the authentication server 105 to a member terminal 109 of a registered member connected in a wired or wireless manner.

On the other hand, classification of the online learning contents by the movement-to-higher-grade or unit is performed when the contents provider 101 provides the contents depending on a set value corresponding to the learning progress of each grade, and classification by the web design of each teaching unit is configuration of a web arbitrary set by the contents providers 101, in which the learning contents can be mainly configured of cartoons, animations, voices, or text.

In addition, educational aptitude of the student is determined based on accumulated records of learning of the student. For example, animation-oriented learning contents can be provided if a mark in history is above the average of all subjects, and text-oriented learning contents can be provided if a mark in mathematics is above the average. It is apparent that the educational aptitude can be combined with biorhythm information of the student and prognostication information based on member information as needed in order to select a genre of the learning contents.

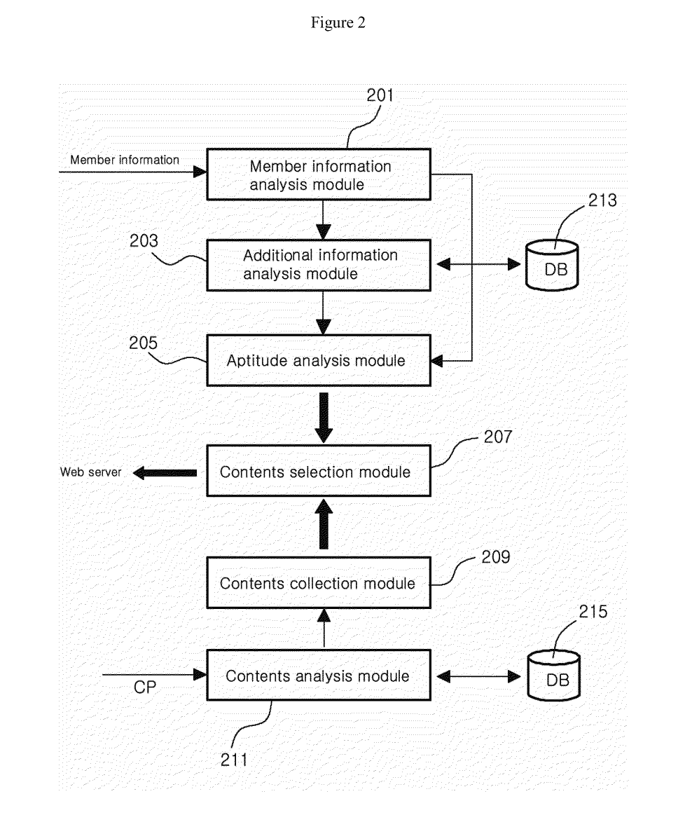

FIG. 2 is a configuration diagram illustrating major functions of an education management server of FIG. 1.

As shown in FIG. 2, the education management server comprises a member information analysis module 201 for receiving personal information of a student based on member registration information of the student from the member terminal 109 and analyzing character and aptitude of the member, an additional information analysis module 203 for extracting information on biorhythm and prognostication of each student from an additional information database 213 based on the personal information of the student, an aptitude analysis module 205 for arithmetically inferring character and inclination of the student in correspondence to output results of the member information analysis module 201 and the additional information analysis module 203, a contents collection module 209 for collecting online learning contents by the movement-to-higher-grade and unit from the plurality of contents providers 101 registered in the authentication server 105 and registering and managing the online learning contents as a contents database 215, a contents analysis module 211 for classifying the online learning contents registered in the contents database 215 by the movement-to-higher-grade, unit, and web design of each unit, and a contents selection module 207 for matching the contents classified by the contents analysis module 211 to one another and providing the matched contents to the web server 107, based on inclination of each member provided by the aptitude analysis module 205.

The prognostication information is information on Saju (fate based on year, month, date, and hour of one's birth), Tojung (fate foretelling based on a book written by Tojung), and blood type, which is used as a means for setting a weighting factor to a result of an aptitude test of a member. For example, personal inclination inputted when a student registers as a member is matched to personal inclination created from additional information on the basis of personal information, and a weighting factor of the inputted personal inclination is determined by converting a degree of similarity according to a result of the matching into numeric information. Here, the personal information inputted when the student registers as a member includes information on the date of birth, character, blood type, and the like of the member, and the additional information database 213 stores inclination information based on Saju determined by the date of birth of the member, inclination information based on Tojung, and inclination information based on the blood type. Accordingly, although the additional information database 213 cannot be used as a factor for determining personal inclination, it is used as a weighting factor of the personal inclination inputted by an individual.

Inclination information of an individual is personal inclination information inputted by a member, which is divided into a plurality of levels of from a passive inclination to an active inclination, and additional inclination information of an individual based on information on Saju, Tojung, and blood type is also divided into the same levels depending on the divided levels. On the other hand, the contents analysis module 211 also divides web designs for the contents of each unit to have the same levels as those of the inclination analysis described above.

The web designs are classified into a cartoon, animation, voice, text, and a combination of two or more of those depending on the inclination, and the inclination levels described above are determined considering colors of the web design, web configuration, and the like.

Although such inclination levels divided by the web design are determined based on the information analyzed depending on the inclination, it is worried about that describing the analysis process in detail may depart from the spirit of the present invention, and thus it will be omitted. However, results of analyzing the inclination will be stored as information having a table form, and the inclination levels are determined based on the information.

Hereinafter, a preferred embodiment of the present invention is described in detail with reference to the accompanying drawings.

First, the member terminal 109 is a terminal capable of wired or wireless communication connection, through which personal and taste information of a member is inputted when he or she joins as a member. The personal information is information on the date of birth, name, blood type, and the like, and the taste information is information on character, aptitude, and the like. The taste information is provided on a web browser so that a user himself or herself may select one of selection items of character, such as ‘inclined to be passive’, ‘inclined to be somewhat passive’, ‘inclined to be somewhat active, ‘inclined to be very active, and the like.

The authentication server 105 performs user authentication based on the personal information when a user joins as a member and provides information on identification ID and password PW as a result of the authentication. After completing the authentication process, the authentication server 105 transmits the authenticated member information and taste information to the education management server 103. The member information analysis module 201 of the education management server 103 registers and manages the inputted personal and taste information and sets a corresponding inclination level based on character information inputted by the member. Next, the member information analysis module 201 provides the additional information analysis module 203 with the personal information.

The additional information analysis module 203 is connected to the additional information database 213, and the additional information database 213 stores prognostication information. The prognostication information includes Saju information, Tojung information, and the like. However, in the present invention, the prognostication information, from which grasp of inclination is expected based on the personal information, may include information other than the Saju and

Tojung information. Since the prognostication information applied in the present invention is not based on a scientific fact, it will be used as an aptitude weighting factor of a member.

Accordingly, the additional information analysis module 203 extracts the prognostication information previously stored in the additional information database 213, based on the personal information such as a date of birth and a name provided by the member information analysis module 201. As described above, the prognostication information is information used to grasp inclination of a member, and the additional information database 213 preferably stores only the information related to grasping the inclination. A prognostication level is determined for the prognostication information extracted by the additional information analysis module 203.

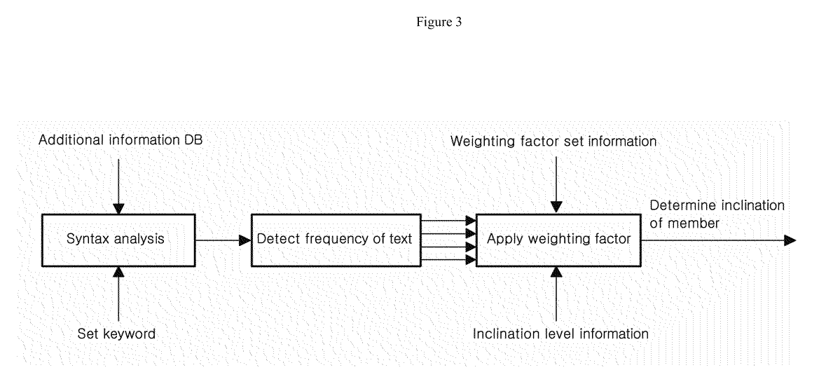

After extracting major keywords mainly from the text of the prognostication information, a prognostication level is determined for corresponding keywords. That is, after performing syntax analysis, a level is determined based on a result of the analysis. As shown in FIG. 3, after receiving the prognostication information extracted from the additional information database 213, the syntax is analyzed based on the keyword information set by a manager. A plurality of methodologies may be suggested for the syntax analysis, and any one of currently used syntax analysis algorithms may be applied. Accordingly, although detailed descriptions of the syntax analysis will be omitted in the present invention, it is assumed that the syntax analysis applied in the present invention is performed based on use of specific text and the number of using the same text.

Accordingly, if the syntax analysis process is completed, specific text is extracted, and frequency of using the text is detected based on the number of using the same text. Then, the main idea of the context is grasped for corresponding prognostication information based on the frequency of using the text, and inclination and character of a corresponding member are inferred as a result. Levels of the inclination and character are determined based on the frequency of using the text, which will be referred to as prognostication level information hereinafter. The prognostication level information is levels of inclination divided based on the prognostication information, and the number of levels does not need to be the same as the number of levels of the inclination level information.

For example, if the inclination level information is divided into five levels and the prognostication level information is divided into 20 levels, levels of the prognostication level information can be divided into five and matched to the inclination level information. Next, as sown in FIG. 3, if frequency of the text is detected and a level of the prognostication level information is determined, a weighting factor for the inclination level information is applied.

The weighting factor is applied such that if the level of the prognostication level information is the same as that of the inclination level information, i.e., if the level of the prognostication level information is level 15 and the level of the inclination level information is 4, they are determined as the same level according to the proportional relation. That is, if the levels are the same as a result of the determination, a set weighting factor is applied to the inclination level information inputted by the member. For example, according to the example described above, if the weighting factor is 120%, the inclination level of the member is raised to level 4.2.

Contrarily, if the level of the prognostication level information is not the same as that of the inclination level information, the weighting factor described above is adjusted to be lowered, e.g., the weighting factor can be set to be 80% of the inclination level information. On the other hand, although the weighting factor described above is described using prognostication information as an example, it is apparent that the weighting factor can be applied through syntax analysis after inclination information based on the blood type is stored in the additional information database 213 as shown in the figure. The additional information database 213 may store information on biorhythm of each member as needed.

As described above, the aptitude analysis module 205 analyzes aptitude of a member in detail based on the additional and personal information. Since precision according to the aptitude analysis may follow precision of contents analysis described below, determination of the precision will be described below.

On the other hand, the plurality of contents providers 101 described above goes through a provider registration process by the authentication server 105. The contents providers 101 completed to be registered provide the education management server 103 with online learning contents and classify the contents by the movement-to-higher-grade and unit of a corresponding subject depending on learning contents.

Since such a classification of contents is arbitrarily set and provided by the contents providers 101, the education management server 103 does not separately request or require contents from the contents providers 101. Accordingly, the contents collection module 209 of the education management server 103 collects contents provided by the plurality of contents providers 101 and registers and manages as the contents database 215.

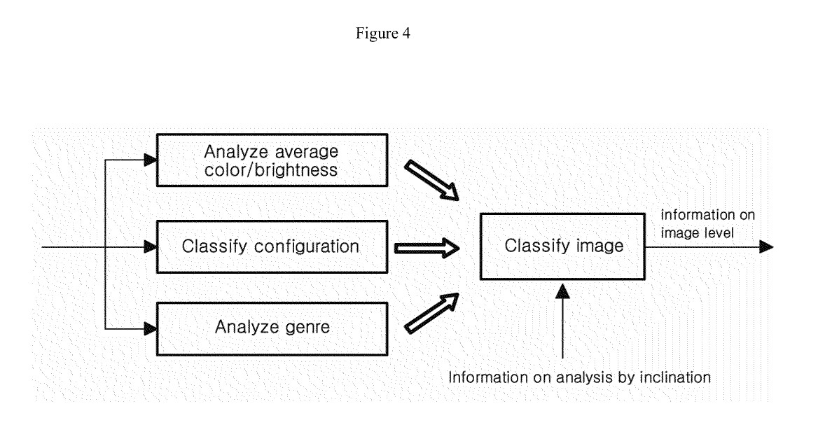

Next, the contents collection module 209 provides the contents analysis module 211 with the registered contents by the unit of contents provider. The contents analysis module 211 classifies the contents by the movement-to-higher-grade, i.e., the grade, subject, and unit, and grasps configuration of each unit. In order to grasp the configuration, as shown in FIG. 4, average color/brightness of a screen is analyzed, and a configuration state of the screen, i.e., simplicity, complexity, or the like, is analyzed. These are analyzed based on the base frame of web configuration and can be determined based on the number of buttons recognized by a member.

In addition, a genre of respective contents is analyzed, and the genre can be set by a manager, which will be classified depending on whether the contents are learning contents of a cartoon type, whether the contents are in the form of an animation, whether teaching is provided through voice, or whether text is utilized as a main educational means. The results of contents analysis such as the analysis of color/brightness, classification of configuration, analysis of genre, and the like described above are provided as coded information, and the contents are classified depending on the taste of the member based on the results of the contents analysis.

As shown in the figure, contents are classified by dividing the results of contents analysis in detail based on information on the analysis by the inclination. The information on the analysis by the inclination is information on the separation of favorite colors, details of contents, genre, and the like based on inclination of character corresponding to the age and gender, for which information constructed as a database is used. This can be performed based on a plurality of inclination analyses, such as a DISC analysis. The DISC is the acronym of Dominance, Influence, Steadiness, and Conscientiousness, which is information on the analysis of behavioral patterns and behavioral styles, and such an analysis is used in the present invention.

Accordingly, colors/brightness, details of contents, and genre of the contents are divided in detail based on the information on the analysis by the inclination. After the colors/brightness, details of contents, and genre of the contents are divided depending on the taste of a user, an image level is determined for each of the contents. The image levels are configured to be the same as the levels of the prognostication described above. In other words, information on the image level is information for determining a level of taste for the contents of each unit provided by the plurality of contents providers 101, which is determined based on the taste corresponding to the age and gender of a member. It is apparent that the information on the image level does not determine the taste itself of the member, but the image level is used as a means for determining a taste.

Next, the contents selection module 207 matches information on an inclination level of a corresponding member provided by the aptitude analysis module 205 to information on an image level provided by the contents analysis module 211. This is searching for an image level that is similar to or the same as an inclination level set for a member, and the contents selection module 207 provides a corresponding member with contents of a contents provider 101 corresponding to the information on the image level. It is apparent that the member determines movement-to-higher-grade or a unit of the contents.

In the present invention as described above, contents provided by a plurality of contents providers are classified depending on the inclination of a member, selected to be appropriate to the movement-to-higher-grade and learning unit of a corresponding member, and provided to the member, thereby enhancing effects and efficiency of education when the same education is provided online.

As described above, the system for providing online learning contents according to the present invention goes out of an educational method determined by contents providers and enhances educational achievements of a member by allowing the member to select contents depending on the aptitude and taste of the member, which has a meaning of developing new markets of online education. Accordingly, industrial availability of the present invention is very high since nitch markets of online education are developed and, furthermore, expansion of online industry markets can be promoted.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

What is claimed is:

1. A system for providing online learning contents, the system comprising:
at least two or more contents providers for configuring and providing online learning contents corresponding to a certain movement-to-higher-grade or a certain grade by the unit;
an education management server for classifying the online learning contents provided by the contents provider by the movement-to-higher-grade, unit, and web design of each unit, analyzing the online learning contents by the degree of difficulty of learning and the gender and taste of a student based on the classification, and providing corresponding contents depending on the educational aptitude and selection of the student;
an authentication server for admitting as a member and authenticating the contents providers, managing and authenticating student members in relation to online contents, and approving online distribution of contents registered in the education management server, on the basis of membership authentication of the contents provider and the student; and
a web server for transmitting certain online contents approved by the authentication server to a member terminal of a registered member connected in a wired or wireless manner.

2. The system according to claim 1, wherein the education management server comprises:
a member information analysis module for receiving personal information of a student based on member registration information of the student from the member terminal and analyzing character and aptitude of the member;
an additional information analysis module for extracting information on biorhythm and prognostication of each student from an additional information database based on the personal information of the student;
an aptitude analysis module for analyzing character and inclination of the member based on the syntax analysis of output results of the additional information analysis module, and setting the analyzed character and inclination of the member as inclination information by level by comparison of the analyzed character and inclination of the member with the personal information of the member information analysis module;
a contents collection module for collecting online learning contents by the movement-to-higher-grade and unit from the plurality of contents providers registered in the authentication server and registering and managing the online learning contents as a contents database;
a contents analysis module for classifying the online learning contents registered in the contents database by the movement-to-higher-grade, unit, and web design of each unit in such a manner as to classify corresponding contents depending on the inclination of the student based on the predetermined analysis information by inclination ; and
a contents selection module for matching the contents classified by the contents analysis module to one another and providing the matched contents to the web server, based on inclination of each member provided by the aptitude analysis module.

3. The system according to claim 2, wherein the prognostication information is information on Saju (fate based on year, month, date, and hour of one's birth), Tojung (fate foretelling based on a book written by Tojung), and blood type, which is used as a means for setting a weighting factor to a result of an aptitude test of a member.

4. The system according to claim 2, wherein the personal information inputted when the student registers as a member includes information on the date of birth, character, blood type, and the like of the member, and inclination level information inputted by each member and the additional information database stores any one or more of inclination information based on Saju determined by the date of birth of the member, inclination information based on Tojung, and inclination information based on the blood type.

5. The system according to claims 2, wherein the aptitude analysis module assigns a weighting factor of an inclination level inputted by each member based on a result of character and inclination analysis by the additional information analysis module.

6. The system according to claim 2, wherein the contents analysis module classifies the contents by design by analyzing average color/brightness of a web screen corresponding to each unit, analyzing simplicity or complexity based on the number of buttons on the screen, and analyzing a genre of respective contents.

7. The system according to claim 6, wherein the information on the analysis by the inclination of the contents analysis module is information on the separation of favorite colors, details of contents, genre, and the like based on inclination of character corresponding to the age and gender, which is obtained based on a DISC abalysis.
